(19) United States
(12) Patent Application Publication
(10) Pub. No.: US 2008/0174143 A1
(43) Pub. Date: Jul. 24, 2008

(54) Convertible Canopy for Rear Compartments of Golf Carts

(76) Inventor: Jerry M. Showalter, Wesley Chapel, FL (US)

Correspondence Address: HOLLAND & KNIGHT LLP;ATTN: STEFAN V. STEIN/ IP DEPT., POST OFFICE BOX 1288, TAMPA, FL, 33601-1288, US

(21) Appl. No.: 12/013,778

(22) Filed: Jan. 14, 2008

Related U.S. Application Data
(60) Provisional application No. 60/884,733, filed on Jan. 12, 2007.

(51) Int. Cl. B60P 7/04

(52) U.S. Cl. 296/100.14

(57) ABSTRACT

A four-sided convertible golf cart cover for covering a rear compartment of a golf cart, including a convertible framework operatively connected above the rear compartment of the golf cart defining a top portion, a front portion, a rear portion, a left side portion and a right side portion, a sectional member operatively connected to the convertible framework, the sectional member including at least one top panel, at least one generally vertical front panel, at least one rear panel, at least one left panel and at least one right side panel, the framework including at least one pivotable member movable from a deployed position to a non-deployed position to respectively move said sectional member from a deployed position covering the rear compartment to a non-deployed position exposing the rear compartment, with the front panel remaining generally vertical throughout the movement of the framework from the deployed position to the non-deployed position.

### CROSS-REFERENCE TO RELATED INVENTIONS

This application claims the benefit of provisional application No. 60/884,733, filed Jan. 12, 2007, the disclosure of which is hereby incorporated by reference herein.

### BACKGROUND OF THE INVENTION

1. Field of the Invention

This invention relates to golf cart covers. More particularly, this invention relates to convertible golf cart covers that may be folded over the rear compartment of a golf cart during precipitation and then folded back out of the way to gain access to the golf club bags positioned in the rear compartment.

2. Description of the Background Art

Presently, there exist many types of golf cart covers designed to cover all or a portion of golf carts. Some are specifically designed to function as a fold-up canopy that covers the rear compartment of the golf cart in which golf clubs are stored. Representative golf cart covers are shown in the following patents, the disclosures of which are each hereby incorporated by reference herein:

| U.S. Patent | Title |
|---|---|
| D497,587 | Golf cart folded canopy cover |
| D469,734 | Canopy for a golf cart |
| D478,859 | External appearance of a golf cart |
| | canopy |
| 4,830,037 | Canopy Attachment for a Golf Cart |
| 5,010,941 | Golf cart drop curtain |
| 5,069,481 | Golf cart club rack and method |
| 5,190,340 | Golf cart rear roof unit |
| 5,388,881 | Portable golf cart cover and method |
| | of manufacture therefor |
| 5,588,690 | Double back golf cart enclosure |
| 6,007,134 | Portable golf cart weathershield |
| | system |
| 6,068,325 | Golf club cover for golf carts |
| 6,076,206 | Medical transport cot collapsible |
| | canopy system |
| 6,216,714 | Golf cart club cover |
| 6,220,647 | Retractable awning for a golf cart |
| 6,227,217 | Roof mounted golf bag canopy |
| 6,227,603 | Portable canopy for golf cart rear |
| | compartment |
| 6,416,109 | Canopy rain cover for a golf cart |
| 6,471,281 | Golf cart canopy and bag support |
| | bracket |
| 6,481,780 | Golf bag covers for use with golf |
| | carts |
| 6,497,444 | Radiation shield for occupants of |
| | golf carts |
| 6,547,312 | Method and apparatus for providing |
| | personalizing information on a golf |
| | cart |
| 6,601,904 | Retractable awning with transition |
| | plate for a golf cart |
| 6,663,161 | Canopy rain cover for a golf cart |
| 6,663,162 | Golf cart retractable canopy |
| 6,692,058 | Golf cart canopy for weather |
| | protection |
| 6,739,486 | Dispenser for dispensing fill |
| | material into a golf course divot |
| | hole and a method and apparatus for |
| | mounting a dispenser to a golf cart |
| 6,761,391 | Full enclosure protective cover for a |
| | golf car with rear golf bag storage |
| | area covering |
| 6,773,052 | Golf cart canopy cover |
| 6,805,396 | Cover for the rear bag compartment of |
| | a golf cart |
| 6,854,747 | Cover assembly for hospital carts |
| 6,953,216 | Cart canopy frame |
| 6,979,044 | Golf cart rearwardly extending canopy |
| | cover |
| 7,093,883 | Golf cart rearwardly extending canopy |
| | cover |
| 7,100,662 | Golf cart club bag protection device |

More specifically, the canopy disclosed in U.S. Pat. No. 4,830,037 is generally known in the industry as a “convertible” cover that is affixed in an upright manner between the rear of the seating compartment and the rear compartment (i.e., the golf club area in which the golf club bags are stowed). Standing upright in its non-deployed position, the convertible does not extend over the golf club bags. Full access is therefore allowed to the golf club bags. However, during precipitation such as rainfall, the convertible golf cart cover may be folded rearwardly to a deployed, generally horizontal, position fully covering the golf club area of the rear compartment and hence the golf club bags. When a golfer wishes to withdraw a golf club from one of the bags (or to replace one), the rear frame of the convertible golf cart cover is simply lifted upwardly from its horizontally-deployed position and then pushed forwardly toward the front of the golf cart to a generally vertical non-deployed position, thereby gaining access to the golf club bags. When finished withdrawing (or inserting) the golf club and selecting a new golf club, the convertible golf cart cover is pulled rearwardly from its vertical non-deployed position toward the rear of the golf cart and then lowered to its horizontally-deployed position to once again cover the golf club bags.

The convertible canopy of U.S. Pat. No. 4,830,037 has achieved considerable success in the marketplace. However, one significant disadvantage of the convertible canopy of U.S. Pat. No. 4,830,037 is the fact that it is only a three-sided canopy composed of left, right and rear side panels. It does not include a front panel. Consequently, when it is folded over the golf club bags to its horizontally-deployed position, the front opening of the rear compartment of the golf cart remains exposed. Precipitation may therefore be blown into the rear compartment through such front opening onto the golf bags. Indeed, when driving the golf cart in the rain, precipitation such as rain often tends to be funneled into the rear compartment.

Prior art modifications to the convertible canopy of U.S. Pat. No. 4,830,037 have included fastening the leading edges of the side panels to the rear back panel of a conventional golf cart cover, such as through hook and loop fasteners or zippers, thereby closing-off the front opening of the canopy to prevent precipitation from blowing into the rear compartment. For golf carts in which the rear compartment is too far away from the seating area, other prior art modifications to the convertible canopy of U.S. Pat. No. 4,830,037 have included sewing side panel extensions to the side panels to bridge the gap from the leading front edges of the side panels of the canopy and the rear back panel of the golf cart cover.

Therefore, it is an object of this invention to provide an improvement which overcomes the aforementioned inadequacies of the prior art devices and provides an improvement which is a significant contribution to the advancement of the golf cart cover art.

Another object of this invention is to provide a four-sided “closed” convertible canopy that does not expose the rear compartment of a golf cart to any blown precipitation.

Another object of this invention is to provide a convertible canopy that includes a front panel that protects the rear compartment of the golf cart from any blown precipitation.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention comprises a four-sided convertible canopy that includes a front panel that protects the rear compartment of the golf cart from any blown precipitation.

More particularly, the front panel is sewn to the leading front edges of the side panels and top panel of a conventional three-sided convertible canopy to form a four-sided canopy. The convertible canopy is installed in an upright, generally vertical position between the seating compartment and rear compartment in which the golf club bags are stowed. In this vertical non-deployed position, the front panel is in a generally vertical, upright position separating the seating compartment from the rear compartment. Further, when the convertible canopy is folded rearwardly to its horizontally-deployed position over the rear compartment to cover the golf club bags, the front panel remains in a generally vertical, upright position. Consequently, in both positions, the front panel prevents precipitation from blowing into the rear compartment in which the golf club bags are stowed. Advantageously, unlike the prior art three-sided convertible canopies, when driving in the rain, the four-sided convertible canopy of the invention does not funnel the rain into the rear compartment. Indeed, the four-sided convertible canopy of the invention left upright in its vertical non-deployed position while driving in light rainfall tends to deflect the rainfall since its front panel always remains in its vertical position.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a rearward perspective view of a prior art golf cart.

FIG. 2 is a rearward perspective view, partially exploded, of the three-sided convertible canopy of U.S. Pat. No. 4,830,037;

FIG. 3 is a frontal perspective view of the four-sided convertible canopy of the present invention comprising a front panel that protects the rear compartment from blown precipitation; and

FIG. 4 is a partial longitudinal cross-sectional view through the upper front corner of the convertible canopy of FIG. 3 showing it attached to the top of the golf cart.

Similar reference characters refer to similar parts throughout the several views of the drawings.

### DETAILED DESCRIPTION OF THE PREFERRED EMBODIMENT

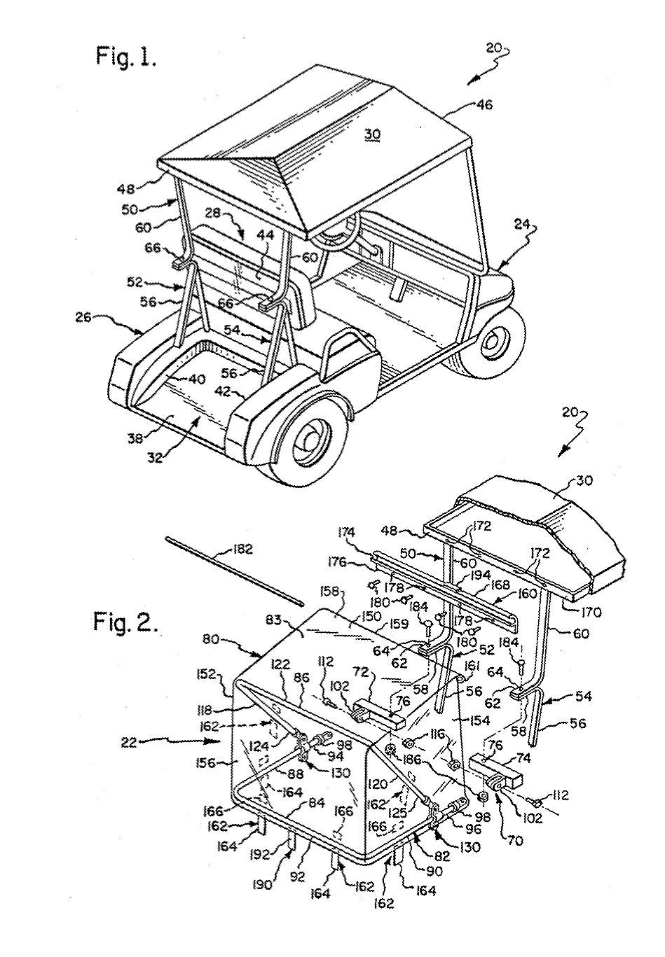

As shown in FIGS. 1 and 2, a motorized golf cart 20 has a front 24, a rear 26, and a seating compartment 28 intermediate of the front 24 and rear 26. The golf cart 20 includes a top roof 30, usually a hard top, for protecting occupants seated in the seating compartment, generally indicated by numeral 28, from adverse weather conditions.

The golf cart 20 also includes a rear compartment, generally indicated by numeral 32, into which golf bags 34 and clubs 36 are loaded into and secured so they do not fall out during driving of the golf cart 20. The rear compartment 32 of the golf cart 20 opens generally rearwardly of the cart 20 and is defined by a bottom 38 upon which the bags 36 are adapted to rest, two opposite sides 40,42 and the back 44 of the cart seat.

The top 30 of the golf cart 20 defines a front edge 46 and a rear edge 48 and is substantially centered over the seating compartment 28. No part of the top 30 is typically disposed directly over the rear compartment 32 leaving the rear compartment 32 uncovered and, hence, exposed to weather precipitation such as rainfall. The top 30 is supported above seating compartment 32 of the golf cart 20 by means of a support post arrangement 50 including rear post assemblies 52,54 extending generally upwardly from the rear of the seating compartment 28. Each post assembly 52 or 54 includes a first rigid post 56 having an arcuate upper end 58 and a second rigid post 60 having a lower arcuate end 62. The second post 60 in each assembly 52 or 54 is disposed above the first post 56 so that its lower arcuate end 62 engagably overlies the upper arcuate end 58 of the first post 56. Each of the engaging arcuate ends 58 and 62 define aligned opening 64, and the first and second posts 56 and 60 of each assembly 52 or 54 are operatively secured to one another by means of a bolt 66 having a shank which extends through the aligned openings 64 and an associated nut which is threadably accepted about the end of the bolt 66.

Referring to FIG. 2, as taught by the prior art convertible canopy of U.S. Pat. No. 4,830,037, the convertible canopy attachment 22 is attachable to the golf cart 20 for purposes of covering bags 34 positioned within the rear compartment 32 and thereby protecting the bags 34 from rainfall and other weather-related precipitation. The prior art canopy attachment 22 includes frame 70 adapted to be attached to the golf cart 20. In the canopy attachment 22, the frame 70 includes two bar sections 72 and 74 each having a first through-opening 76 and a second through-opening 78 defined therein. Each bar section 72 or 74 is elongated in shape with two opposite ends and is relatively short in length as measured between its ends. The first through-opening 76 defined in each bar section 72 or 74 is located adjacent one end thereof, and the second through-opening 78 defined in each bar section 72 or 74 is located adjacent the other end thereof.

The prior art canopy attachment 22 further includes a convertible canopy, generally indicated by numeral 80, secured to the frame 70 and movable relative thereto between operative and inoperative conditions, described hereinafter. The canopy 80 includes a frame structure 82 and a cover section 83 supportedly attached to the frame structure 82 for movement therewith. The frame structure 82 includes a pair of generally U-shaped metal brackets 84 and 86 which are pivotally attached to one another and to the frame means 70.

The bracket 84 includes two parallel cylindrically-shaped legs 88,90 and an elongated cylindrically-shaped connecting portion 92 extending between the legs 88,90. The length of each connecting portion 92 corresponds generally to the width of the rear compartment 32 of the golf cart 20, the length of each bracket leg 88 or 90 corresponds generally to the width of the rear compartment 32 of the golf cart 20, and the length of each bracket leg 88 or 90 corresponds generally to the depth of the rear compartment 32. Each leg 88 or 90 of the bracket 84 defines an end portion 94 or 96 which is pivotally connected to a corresponding one of the bar sections 72 and 74 of the frame means 70. To this end, a member 98 having a ring portion 100 is fixedly secured to each leg end portion 94 or 96 and a member 102 having a clevis portion 104 is fixedly secured to each bar section 72 or 74. The member 98 includes a sleeve portion 106 attached to so as to extend from the ring portion 100, and the sleeve portion 106 is positioned about and fixedly secured, as by welding, to the corresponding leg end portion 94 or 96.

The bracket 86 includes two parallel cylindrically-shaped legs 118,120 and an elongated, cylindrically-shaped connecting portion 122 extending between the legs 118 and 120. The length of each connecting portion 122 is about equal to the width of the rear compartment 32 of the cart 20, and the length of each bracket leg 118 or 120 is slightly shorter than the length of each bracket leg 88 or 90 of bracket 84. Each leg 118 or 120 of the bracket 86 defines an end portion 124 or 125 which is pivotally connected to a corresponding one of the legs 88 and 90 of the bracket 84. Each member 126 includes a sleeve portion 132 attached so as to extend from the ring portion 128, and the sleeve portion 132 is positioned about and fixedly secured, as by welding, to the corresponding leg 88 or 90. The clamp 130 includes two clamp members 134 and 136 positioned about the corresponding leg 88 or 90, and each clamp member 134 or 136 includes two opposite flanges 138,140 through which apertures are defined. The clamping members 134 and 136 are positioned on opposite sides of the corresponding leg 88 or 90 so that the leg 88 or 90 is sandwiched therebetween and the apertures defined in opposing flanges of the clamping members 134 and 136 are aligned.

The cover section 83 of the canopy 80 includes a sheet 150 of waterproof, flexible material folded and joined along appropriate edges as to provide a covering draped across the brackets 84 and 86. The cover section 83 is preferably constructed of a transparent plastic and defines two opposite side sections 152 and 154, a back section 156 and a top section 158. The side sections 152 and 154 are operatively arranged against a corresponding pair of bracket legs 88,118 or 90, 120, the back section 156 is arranged so as to span the space defined between the connecting section 92 and 122 of the brackets 84 and 86, and the top section 158 is arranged adjacent the connecting section 122 so as to extend forwardly thereof. The top section 158 defines a forwardmost edge portion 159 which is folded back and stitched upon itself so as to form a sleeve 161 having an opening extending from one side of the cover section 83 to the other.

The canopy 80 further includes an attachment, generally indicated 160, for securing the cover section 83 to the brackets 84,86. In the canopy attachment 22, the attachment 160 preferably includes hook and loop type fasteners 162, such as are sold under the trade designation Velcro, for releasably attaching the cover section 83 to the brackets 84,86. Each hook and loop type fastener 162 includes a hook bundle strip 164 stitched to the cover sheet 150 at appropriate locations thereon adjacent a corresponding bracket 84 or 86 and a loop bundle strip 166 stitched to the cover sheet 150 adjacent the hook bundle strip 164. By wrapping each hook bundle strip 164 about the adjacent bracket 84 or 86 and pressing the strip 164 against its corresponding loop bundle strip 166, the cover section is releasably secured to the brackets 84 and 86.

The canopy attachment 22 further includes an attachment member 168 adapted to be secured to the back edge 48 of the top 30 of the cart 20. The back edge 48 defines a planar and rearwardly-facing surface 170 and for purposes of accommodating the attachment member 168 thereto includes a series of preformed threaded openings 172 extending along the edge 48. The attachment member 168 is elongated in shape and includes an upper section 174 and a lower section 176. The upper section 174, as viewed in cross section, is somewhat C-shaped and the lower section is platen-like and joined to the upper section so as to depend downwardly therefrom. Defined along the length of the lower section 176 is a series of openings 178 which, when operatively positioned against the back edge 48 of the cart top 30, are aligned with the threaded openings 172 defined therealong. To secure the attachment 168 to the back edge 48, shanks of screws 180 are inserted into the aligned openings 178 and 172 and tightened within the threads of the openings 172. The attachment member 168 can be constructed of any of a number of suitable materials, such as plastic.

With the attachment member 168 operatively secured to the back edge 48 of the cart top 30, the upper section 174 opens rearwardly of the cart 20. As will be explained hereinafter, the attachment member 168 cooperates with an elongated dowel element 182 for securing the forwardmost edge 159 to the cart top 30.

In order to install the canopy attachment 22 to the golf cart 20, each bolt 66 is removed from its secured relationship with the post assembly 52 or 56 to expose the aligned openings 64. Each bar section 72 or 74 is then operatively positioned in engagement with the arcuate upper end 58 of the corresponding post 56 so that its through-opening 76 is aligned with a corresponding one of the aligned openings 64, and a bolt 184 is inserted through each alignment of openings 64 and 76. Nuts 186 are then threaded upon the shank of the bolts 184 to tightly secure the bar sections 72 and 74 to the post assemblies 52 and 54. The shank of each bolt 184 is of sufficient length to extend through the aligned openings 64 and 76 and threadably accept the nut 186. It follows that by securing the bar sections 72 and 74 to the post assemblies 52 or 54, the brackets 84 and 86 are operatively secured to the golf cart 20.

The forwardmost edge 159 of the cover section 158 is securable to the attachment member 168 by the dowel element 182, mentioned earlier. The dowel element 182 is elongated in shape and is about the same length as the attachment bracket 168. Furthermore, the outer diameter of the dowel element 182 is small enough to be slidably received endwise by the upper portion 174 of the attachment member 168 when inserted endwise therein yet large enough to prevent the dowel element 182 from passing through the rearwardly-facing opening. In the illustrated embodiment 22, the dowel element 182 is in the form of tubing constructed of flexible plastic, but it will be understood that the dowel element 182 can be constructed of any of a number of suitable materials.

To secure the forwardmost edge 159 of the top section 158 of the cover to the attachment member 168, the sleeve 161 formed in the forwardmost edge 159 is directed through the opening of the upper portion 174 so as to be positioned therein. One end of the dowel element 182 is then directed into one end of the opening defined in the sleeve 161 and forced therethrough until each end of the dowel element 182 corresponds with an end of the sleeve 161 and an end of the attachment member 168. The sleeve 161, and hence the forwardmost edge 159, is thereby secured to the attachment member 168 as the sleeve 161 is captured between the outer surface of the dowel element 182 and the inner walls of the upper section 174 having a generally C-shaped opening as described. The dowel element 182 is prevented from migrating out of the sleeve 161 by the frictional engagement therewith.

With the bar sections 72 and 74 operatively secured to the post assemblies 52,54 and the forwardmost edge 159 of the cover section 158 secured to the attachment member 168 as aforesaid, the canopy 80 is in condition for movement between its generally vertical non-deployed and its generally horizontal deployed positions. More specifically, in its deployed position, the canopy 80 is folded over the golf bags 34 and clubs 36 to thereby protect them from rainfall and other weather-related precipitation. In such deployed position, brackets 84 and 86 are supported by the cover section 83 and from the attachment member 168 so that the bracket 84 is arranged in plane oriented substantially horizontally and the bracket 86 is arranged in a plane oriented at an acute angle in relation to the horizontal. In such a condition, the back and top sections 156 and 158, respectively, of the cover section 83 are held in a taut condition between the connecting section 92 of bracket 84 and the attachment member 168 as the bracket 84 is held in the illustrated cantilevered condition by the cover section 83. Furthermore, the side sections 152 and 154 of the cover section 83 are each held taut in a planar condition against a corresponding set of bracket legs 88, 118 and 90,120. The weight of the bracket 84 has been found to be effective in maintaining the canopy means 80 in the operative condition.

When in its upright, generally vertical, non-deployed position, the brackets 84 and 86 are each oriented in planes which may be slightly inclined to the vertical. Furthermore, the back and top sections 156 and 158, respectively, drape between a corresponding pair of the bracket connecting sections 92 and 122 and between the bracket connection section 122 and the attachment member 168 while each of the side sections 152 and 154 of the cover section 83 is limp and folded upon itself. The canopy 80 can be releasably secured in the non-operative condition by a fastener such as a hook and loop-type fastener 190 including a loop bundle strip 192 attached at one end to the back section 156 of the cover section 83 and a hook bundle strip 194 fixedly secured atop the attachment member 168. By wrapping the free end of the strip 192 about the bracket connecting sections 92 and 122 and pressing the strip 192 against the hook bundle strip 194, the canopy 80 is releasably secured in the non-operative condition.

As the canopy 80 is moved from its deployed to its non-deployed positions, the bracket 84 pivots relative to the bar sections 72 and 74 and the bracket 86 pivots relative to the bracket 84. Consequently, the brackets 84 and 86 are moved from an angularly related relationship to a condition at which the connecting sections 92 and 122 of the brackets 84 and 86 are positioned adjacent one another. Furthermore, the back 156 of the cover section 83 is permitted to drape and become limp as a natural result of the bringing together of the bracket connecting sections 92 and 122, and the top 158 of the cover section 83 is permitted to drape and become limp as a natural result of the bringing together of the bracket section 122 and the attachment member 168. Hence, the cover section 83 moves between taut and limp conditions in an accordion-style fashion as the canopy means 80 are moved between operative and non-operative conditions.

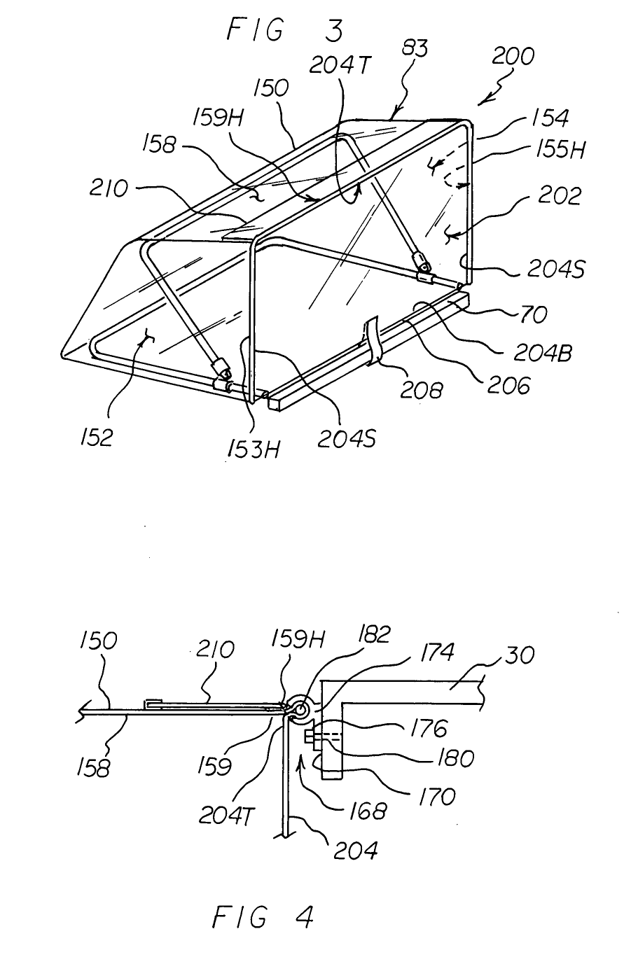

As shown in FIGS. 3 and 4, in accordance with the present invention, the four-sided convertible canopy 200 of the invention improves upon the prior art three-sided canopy attachment 22 by the addition of a front panel 202. More specifically, the front panel 202 preferably comprises a transparent or translucent sheet of material 204 in a preferably generally rectangular configuration. Further preferably, the sheet of material 204 comprises a flexible sheet of material.

The width of the rectangular sheet of material 204 is dimensioned to horizontally extend between and be affixed to the forwardmost edges 153 and 155 of opposing side sections 152 and 154 of the sheet 150 of the cover section 83 whereas its height is dimensioned to vertically extend between and be affixed forwardmost edge 159 of the top section 158 of the sheet 150 of the cover section 83 and the frame 70.

In its preferred form of being composed of a transparent or translucent flexible plastic, the side edges 204S of the sheet of material 204 are preferably affixed to the sheet 150 by sewing the side edges 202S of the into the side hem 153H and 155H of the sheet 150. Likewise, the top edge 204T of the sheet of material 204 is affixed to the sheet 150 by sewing the top edge 204T of the sheet of material 204 into the hem 159H of the forwardmost edge 159 of the top section 158 of the sheet 150. In lieu of sewing, the side edges 204S and the top edge 204T may be removably fastened to the respective side hems 153H and 155H or the top hem 159H by a fastener such as by hook and loop fasteners, zippers, snaps or the like.

The bottom edge 204B of the sheet of material 204, which is preferably finished with a hem 206, is fastened to the frame 70 (illustrated in its preferred form as a continuous member). Many different types of fasteners may be employed such as a hook and loop straps 208 sewn to the hem 206 that are wrapped around the frame 70 and fastened back onto itself. Alternatively, several hook and loop straps 208 may be positioned along the length of the frame 70. Still alternatively, fasteners may comprise a zipper having one side affixed to the frame 70 and the other side affixed (e.g., sewn) to the bottom edge 204B, allowing the bottom edge 204B to be removably zippered to the frame 70. In lieu of a zipper, a continuous strip of a hook & loop fastener may have one component affixed to the frame 70 and the other component affixed (i.e., sewn) to the bottom edge 204B, thereby allowing the bottom edge 205B to be removably fastened to the frame means 70.

It is noted that the front panel 202 is held in a generally vertically position irrespective whether the canopy attachment 22 is non-deployed or deployed. Consequently, the front panel 202 functions to protect the rear compartment 32 in which the golf bags 34 are stored from any frontally blown precipitation, such as would often occur during driving the golf cart in the rain.

Finally, it is noted that an optional flap 210 may be sewn along the hem 159H of the forwardmost edge 159 of the top section 158 of the sheet 150. The flap 210 is of sufficient vertical length to be able to wrap around the convertible canopy 200 when in its non-deployed position for it to be tucked under the flap 210, whereupon the flap 210 is then snapped thereto. Similar to my related invention disclosed in U.S. Pat. No. 4,773,694, the flap 210 functions to protect the convertible canopy 200 during extended periods of non-deployment from being contaminated by debris and other contaminates.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A four-sided convertible golf cart cover for covering a rear compartment of a golf cart, comprising in combination:
a convertible framework operatively connected above the rear compartment of the golf cart defining a top portion, a front portion, a rear portion, a left side portion and a right side portion;
a sectional member operatively connected to said convertible framework, the sectional member including at least one top panel, at least one generally vertical front panel, at least one rear panel, at least one left panel and at least one right side panel;
said framework including at least one pivotable member movable from a deployed position to a non-deployed position to respectively move at least said top panel of said sectional member from a deployed position covering the rear compartment to a non-deployed position exposing the rear compartment, with said front panel remaining generally vertical throughout said movement of said framework from said deployed position to said non-deployed position.

2. The four-sided convertible golf cart cover as set forth in claim 1, wherein said front panel comprises a transparent sheet of material.

3. The four-sided convertible golf cart cover as set forth in claim 1, wherein said front panel comprises a translucent sheet of material.

4. The four-sided convertible golf cart cover as set forth in claim 1, wherein said front panel comprises a flexible sheet of material.

5. The four-sided convertible golf cart cover as set forth in claim 4, wherein said front panel comprises a generally rectangular configuration.

6. The four-sided convertible golf cart cover as set forth in claim 5, wherein said front panel comprises a width and height to extend across said front portion of said framework.

7. The four-sided convertible golf cart cover as set forth in claim 6, wherein said front panel comprises left and right side edges sewn to said left and right side panels, respectively.

8. The four-sided convertible golf cart cover as set forth in claim 6, wherein said front panel comprises a top edge sewn to said top panel.

9. The four-sided convertible golf cart cover as set forth in claim 6, wherein said front panel comprises left and right side edges removably fastened to said left and right side panels, respectively.

10. The four-sided convertible golf cart cover as set forth in claim 6, wherein said front panel comprises a top edge removably fastened to said top panel.

11. The four-sided convertible golf cart cover as set forth in claim 1, wherein said front panel comprises a bottom edge fastened to said framework.

12. The four-sided convertible golf cart cover as set forth in claim 11, wherein said bottom edge of said front panel is fastened to said framework by a hook and loop fastener.

13. The four-sided convertible golf cart cover as set forth in claim 11, wherein said bottom edge of said front panel is fastened to said framework by a zipper having one side affixed to the framework and another side affixed to said bottom edge.

14. The four-sided convertible golf cart cover as set forth in claim 1, further including a flap to wrap around said top panel and said rear panel when in its non-deployed position.
